(19) United States
(12) Patent Application Publication
(10) Pub. No.: US 2020/0377061 A1
(43) Pub. Date: Dec. 3, 2020

(54) SELF-POSITIONING WASHING GANTRY

(71) Applicant: WashTec Holding GmbH, Augsburg (DE)

(72) Inventors: Florian Endress, Augsburg (DE); Ulrich Kölbl, Friedberg (DE); Michael Schwärzer, Aindling (DE); Ferdinand Conrad, Augsburg (DE); Stefan Wölfle, Augsburg (DE)

(21) Appl. No.: 16/491,831

(22) PCT Filed: Mar. 8, 2018
(86) PCT No.: PCT/EP2018/055810

§ 371 Date: Sep. 6, 2019

(30) Foreign Application Priority Data
Mar. 9, 2017 (DE) 10 2017 105 061.2

(51) Int. Cl. B60S 3/04

(52) U.S. Cl. CPC B60S 3/04

(57) ABSTRACT

A gantry washing system includes a gantry that can be moved relative to a vehicle, on which gantry washing devices for washing a vehicle are arranged, a control device for controlling the movement of the gantry, and at least one detection device for detecting a position of the vehicle. The gantry of the gantry washing system can be freely moved and oriented relative to the vehicle. The detection unit can further detect an orientation of the vehicle. The control unit is designed to position and move the gantry in a predetermined manner relative to the detected vehicle position and orientation.

### CROSS REFERENCE TO RELATED APPLICATIONS

This application is the United States national phase entry of International Application No. PCT/EP2018/055810, filed Mar. 8, 2018, which claims the benefit of priority of German Application No. 10 2017 105 061.2, filed Mar. 9, 2017. The contents of International Application No. PCT/EP2018/055810 and German Application No. 10 2017 105 061.2 are incorporated by reference herein in their entireties.

### FIELD

The invention relates to gantry washing system.

### BACKGROUND

In practice, gantry washing systems have so far been known in which the vehicle driver drives the vehicle to be washed to a washing position. In said position, a gantry of the car wash, equipped with various washing and treatment facilities, is guided along rails on the floor and/or ceiling and moved relative to the vehicle in the longitudinal direction during the washing process. Such a rail system for a washing gantry is expensive and inflexible due to the stationary installation. In addition, rails running on the floor cause a non-negligible risk of accidents for customers or maintenance personnel moving through the system.

With such well-known systems, vehicle positioning in or under the gantry depends on the vehicle driver. Some vehicle drivers do not dare to enter the mostly narrow (washing) facilities and position the vehicle correctly therein. Another disadvantage of such gantry washing systems is that a vehicle which is not parked optimally (i.e. off-center or at an angle) has a negative effect on the washing result, especially in the area of the rims. The known systems are therefore susceptible to human error, which can result in damage to the vehicle by the gantry (side mirror) or in scratching of the rims by the rails.

At least the latter problem has so far been addressed vaguely by the so-called wheel guiding rails in gantry washing systems, as they are known, for example, from DE 10 2014 112 052 B3. The utility model DE 299 08 866 U1 also deals with this problem and proposes a gantry washing system which is equipped with several cameras for detecting an entering vehicle. Based on the detected camera data, instructions are issued on a screen to help the driver in positioning the vehicle optimally under the gantry.

Despite these state-of-the-art guidance and auxiliary devices, a human error when driving in cannot be completely ruled out. In addition, there are people who, e.g. due to claustrophobia, lack of driving experience, old age or similar reasons, do not wish to enter a gantry washing system despite such systems.

This is why there is a long-standing need in the field of gantry washing systems to provide a system that makes driving in and positioning a vehicle in a car wash obsolete.

### SUMMARY

A preferred goal of this invention is to significantly simplify the positioning of the vehicle in the car wash.

Furthermore, a preferred goal of this invention is to provide a gantry washing system that can be quickly assembled and disassembled or repositioned compared to conventional systems.

The above mentioned goals and tasks are solved according to the invention by a gantry washing system with the features described herein.

According to a first aspect of the invention, a gantry washing system according to the invention comprises a gantry that can be moved relative to a vehicle, on which gantry washing devices for washing a vehicle are arranged, a control device for controlling a movement of the gantry and at least one detection device for detecting a position of the vehicle. In addition to the position of the vehicle, the detection device can also detect an orientation of the vehicle. According to the invention, the gantry is designed such that it can be freely moved and oriented relative to the vehicle.

The control unit is also designed to position the gantry in a predetermined manner relative to the detected vehicle position and orientation and, if necessary, to align and move it. In other words, the invention reverses the previous positioning principle of gantry washing systems, so that it is not the vehicle which has to be positioned in the gantry, but the gantry positions itself with respect to the vehicle.

For this, it is necessary that the gantry is freely movable in relation to the parked vehicle. Preferably, the gantry can have at least two substantially horizontal degrees of freedom for translation and at least one substantially vertical degree of freedom for rotation. It is particularly advantageous if the entire gantry can be moved with the degrees of freedom mentioned above and not just parts or subassemblies of it. In other words, the gantry according to the invention can preferably be moved over the area by means of floor-level movement, i.e. can move in the manner of trackless industrial trucks. To put it another way, the gantry can be moved in longitudinal, transverse and any other intermediate directions and can a rotate around its own vertical axis. Based on this aspect of the invention, the gantry can be designed to be freely movable independently of rails or other control systems. In addition to the advantage of free mobility, this also has the advantage of reducing the risk of accidents in the area of the system and making it easier to assemble and disassemble the gantry washing system.

According to another preferred embodiment, the gantry may have an omnidirectional drive unit, e.g. in the form of omnidirectional wheels or drive/turn modules, with the help of which it can be freely moved relative to the vehicle. Such omnidirectional drive units offer the advantage of good maneuverability, since a gantry equipped with them can move in any direction at any time. This helps to be able to position and align the gantry optimally with respect to the vehicle in the smallest of spaces.

It is particularly preferred that the omnidirectional drive unit described above is embodied by so-called mecanum-type rollers, also called Ilon wheels or Omni wheels. Compared to other omnidirectional drive units, these have the advantage of a particularly smooth run and of being suitable for high loads.

According to an alternative aspect, the gantry can be freely movable by means of a kinematic system on the basis of an articulated arm or gantry robot. With such an embodiment, the (washing) gantry could be suspended from a robot gantry or manipulator. This has the advantage that no floor contact or floor connection of the gantry is necessary and is particularly suitable for uneven surfaces. In other words, the gantry washing system can be designed in the manner of conveyors that have no contact to the floor. Such an embodiment also offers the advantages of good maneuverability of the gantry in the smallest of spaces. In addition, such an embodiment also allows the gantry to be lowered from above onto a vehicle.

According to another preferred embodiment, the gantry washing system may have a marked parking area. Preferably, the detection device can be designed to identify the marked parking area.

Alternatively, the gantry can be designed to identify its position relative to the marked parking area via an internal sensor system, e.g. internal rotary position transducers or encoders, in particular using a reference position.

According to a further aspect of the invention, the at least one detection device and/or the control device can be arranged in or on the gantry. In this way, the gantry can act largely autonomously and is not restricted in its radius of action by a stationary control system or detection device.

According to a further preferred embodiment, the detection device may have non-contact sensors, in particular optical and/or light-sensitive and/or acoustic and/or radiation-sensitive sensors individually or in combination.

Preferably, the detection device may have at least one camera. For example, low-resolution cameras can be used, which orient themselves mainly toward the switched-on headlamps of a vehicle, or preferably high-resolution cameras, which also enable a contour recognition.

An acoustic detection device used can preferably be designed as an ultrasonic detection device with an ultrasonic transmitter and a corresponding signal receiver.

As a radiation detection device, preferably radar systems with at least one transmitter and at least one receiver for electromagnetic radiation can be used. Such a detection based on radar radiation has the advantage of being less affected by environmental influences prevailing in a car wash such as water vapor and noise than other detection device variants.

The detection device used can preferably have a particularly high operational safety and can work reliably and accurately even under the environmental conditions prevailing in a vehicle washing system.

According to a further exemplary embodiment, the detection device may be designed to detect the contour at least of a vehicle surface and the control device may be designed to calculate an orientation, possibly also a longitudinal and/or transverse central axis of the vehicle, from the detected contour. In other words, the vehicle orientation can be calculated on the basis of recognized symmetries in the vehicle contour detected by the detection device. In this way, an individual adaptation of the gantry alignment to different vehicle types is possible. Preferably, the gantry can also move along the detected longitudinal and/or central axis of the vehicle during the washing process, especially in the middle. Alternatively, the headlights of the vehicle may also be used to determine its orientation and, if necessary, its longitudinal center axis.

According to a further aspect, the control device can also be used to calculate a height profile from the detected vehicle contour for the targeted control of the gantry washing devices, in particular a horizontal washing brush. The control device can also be used to calculate a width profile for the targeted control of vertical washing brushes and/or wheel washing brushes.

According to a further aspect, a method according to the invention for washing a vehicle by means of a gantry washing system has the following steps:
parking a vehicle on a predetermined, in particular marked area;
detecting a position and an orientation of the parked vehicle;
aligning a freely movable gantry on the basis of the detected vehicle position and positioning the gantry at a predetermined position relative to the vehicle; and
washing the vehicle by means of gantry washing devices arranged on the gantry.

### BRIEF DESCRIPTION OF THE DRAWING FIGURES

Further special features and advantages result from the following description of preferred exemplary embodiments on the basis of the drawings in which:

FIG. 1 is a schematic view of a washing gantry according to a preferred embodiment and a representation of a travel and positioning process with respect to a parked vehicle;

FIG. 2 is a further schematic view of the washing gantry according to the first embodiment and a representation of a travel and positioning process for a vehicle parked at an angle;

FIG. 3 is an exemplary representation of a mecanum-type wheel;

FIG. 4 is an Illustration of the functional principle of mecanum-type wheels; and

FIG. 5 shows a principle sketch of the control system of a gantry according to the first embodiment.

### DETAILED DESCRIPTION

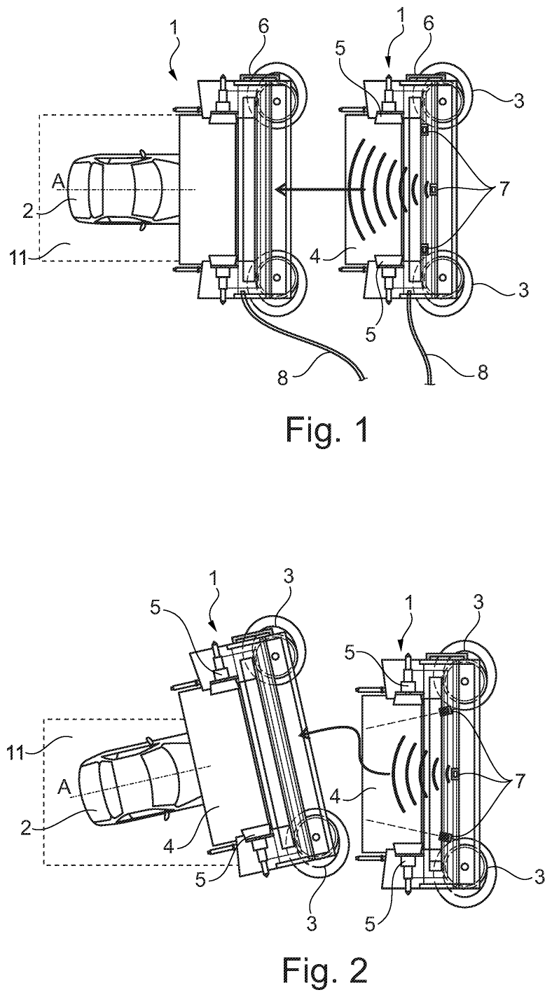

FIG. 1 schematically shows a gantry washing system of the invention according to a preferred exemplary embodiment. The gantry washing system has a washing gantry 1 with various gantry washing devices 3, 4, 5 (henceforth called gantry 1). The gantry 1, in turn, has two vertical gantry columns and, arranged at their upper ends, a traverse extending transversely to them. Washing brushes 3 are arranged on the traverse and can be rotated about vertical axes. They can be moved along the longitudinal direction of the traverse to wash the side surfaces and the front and rear side of a vehicle 2. A washing brush 4 arranged horizontally above the vehicle roof can be moved vertically along the columns. In addition, the gantry 1 depicted has wheel washing brushes 5 which are intended for washing and treating the vehicle wheels and rims and are arranged at the lower section of the inner sides of the columns. In addition, the gantry 1 has facilities for the application of water and treatment agents as well as for drying the vehicle 2, which, however, are not shown further.

In addition, the gantry 1 comprises a control device 6 for controlling its movements as well as a detection device 7 for detecting a vehicle 2 to be washed.

The washing gantries known to date in prior art can be moved along rails in the longitudinal direction of a vehicle 2 in order to wash the vehicle 2 with the help of the gantry washing devices 3, 4, 5 mentioned above. For this purpose, it is necessary that the vehicle 2 is positioned centrally and parallel relative to the rails, as the conventional washing gantries are strongly restricted in their freedom of movement by the rail guide. More precisely, they have only one single degree of translational freedom along the longitudinal direction of the rails.

In contrast to conventional car wash gantries, the gantry 1 according to the invention is able to freely move and position itself relative to the vehicle 2 to be washed independently of any rail or guidance system. In this way, the gantry 1 according to the invention, as shown in FIG. 2, can be optimally positioned relative to and above the vehicle 2 even if it is parked at an angle and off-center with respect to the gantry 1.

The free mobility of the gantry 1 of the shown exemplary embodiment is realized by an omnidirectional drive unit, which in this case is arranged at the columns of the gantry 1. There are also other conceivable drive units, e.g. conventional wheel suspensions or chain drives, which are common for trackless floor conveyors, but omnidirectional drive units have the advantage of particularly good maneuverability in the smallest of spaces.

Examples of omnidirectional drive units are so-called omnidirectional wheels and drive/turn modules. Omnidirectional wheels are distinguished in particular by the fact that on the circumferential surface of each main wheel there are additional auxiliary wheels, mostly cylindrical or barrel-shaped, whose axes of rotation are orthogonal to the axis of rotation of the main wheel. Another example of omnidirectional drive units are the so-called drive/turn modules, which are also used with moon probes, for instance. A drive/turn module is in principle a classic drive wheel that can also be actively rotated around its vertical axis.

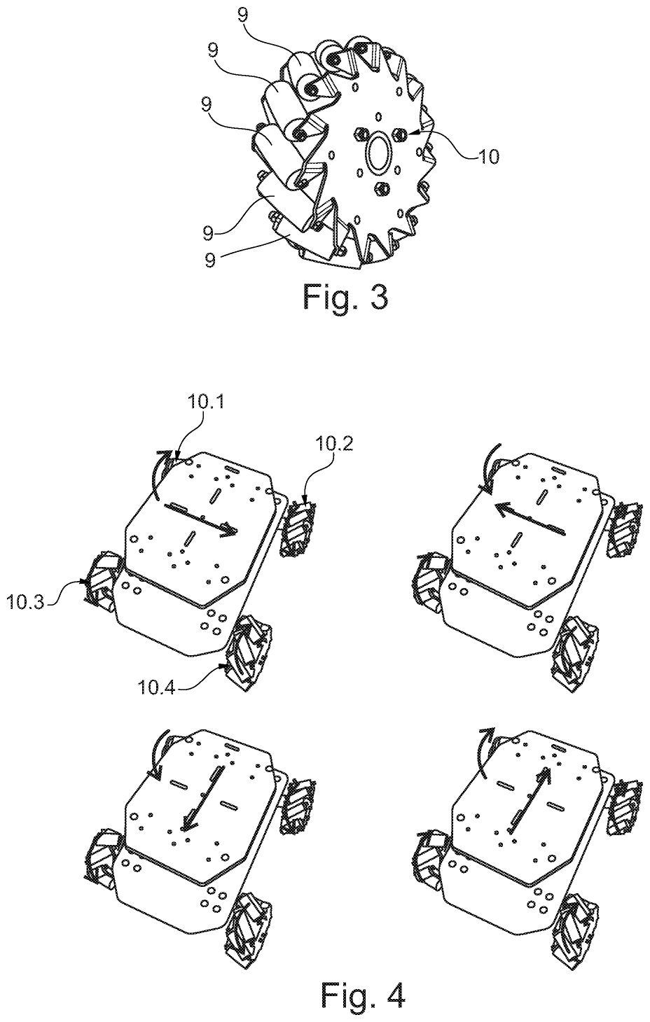

In the preferred exemplary embodiment shown, the omnidirectional drive unit is formed by so-called mecanum-type wheels or Ilon wheels 10. Mecanum-type wheels 10 are distinguished in particular by the fact that crowned rollers (auxiliary wheels) 9 are arranged at an angle of a 45° to the axis of rotation along the circumferential surface (see FIG. 3). The inclined position of the auxiliary wheels 9 results in a better closed running surface contour compared to omnidirectional wheels, which results in a smoother motion.

In principle, at least four units are required for the optimum implementation of an omnidirectional drive unit with mecanum-type 10 wheels, which advantageously form a front wheel pair 10.1, 10.2 and a rear wheel pair 10.3, 10.4. The inclined axes of rotation of the auxiliary wheels 9 of the diagonally opposite wheels 10.1 and 10.3 or 10.2 and 10.4 have the same orientation. Preferably all wheels 10 of the gantry 1 can be controlled individually or have their own drive unit 12.

FIG. 4 shows an example of some travel modes of a mecanum-type drive unit 12. If all mecanum-type wheels 10 turn in a running direction of the main wheels, the gantry 1 moves in the corresponding main direction (see lower illustrations of FIG. 4). If the diagonally opposite wheels 10.1, 10.3 or 10.2, 10.4 rotate in the same direction, but the individual diagonals rotate in opposite directions, the gantry 1 can move from a standing position transverse to the running direction of the main wheels 10 (see upper illustrations of FIG. 4). Likewise, e.g. a diagonal movement is possible if only the wheels 10.1, 10.3 or 10.2, 10.4 turn on one diagonal.

In the preferred exemplary embodiment, two mecanum-type wheels are arranged on the outside of each column of the gantry 1. However, an embodiment with four mecanum-type wheels per column is just as feasible.

In order to be able to identify a parked vehicle 2, the gantry 1 according to the preferred embodiment shown is equipped with a detection device 7, which among other things comprises sensors for detecting a vehicle position and orientation. Preferably, the detection device 7 is designed to identify a contour of a vehicle surface. Examples of suitable sensor systems are cameras, microphones and radiation sensors for radar waves. In addition, the detection device 7 can have laser line projectors according to a preferred embodiment and capture the light fans generated by them or their reflections by means of cameras equipped with appropriate filters. According to a further preferred exemplary embodiment, the detection device 7 can have one or more ultrasonic transmitters as well as a number of corresponding microphones in order to calculate an approximated vehicle contour from the echo. A further alternative embodiment of the detection device 7 provides for a number of radar wave transmitters and receivers, which are used to detect vehicle position and orientation.

In the preferred exemplary embodiment, the control device 6 designed to calculate from the vehicle contour data detected by the detection device 7 a longitudinal and/or central axis A of the vehicle 2, along which the gantry 1 is positioned and moved for washing (preferably in the middle and parallel).

In the preferred exemplary embodiment, the control device 6 is also able to calculate a height and width profile of the vehicle 2 on the basis of the detected vehicle contour and to optimally control the washing brushes 3, 4, 5 as well as the other treatment facilities in a manner adapted to these calculated profiles. The height and width profiles of the vehicle 2 can be detected either at the beginning, while detecting the position and orientation of the vehicle 2 or at a later point in time. A continuous detection in real time is also possible.

In the gantry washing system according to the invention shown here, the detection device 7 is arranged in or on the gantry 1 so that the latter is able to autonomously identify a vehicle 2 or its position and orientation. In other words, the gantry 1 according to the invention is not dependent on stationary devices for the detection of the vehicle 2.

The control device 6 is also integrally installed in the gantry 1 with the preferred exemplary embodiment. In the exemplary embodiment shown, the control device 6 has, among other things, a CPU, electric motors for the individual mecanum-type wheels and an internal sensor system for detecting various travel parameters and for calculating the position of the gantry 1.

The gantry washing system 1 shown in FIGS. 1 and 2 has a marked area 11 for parking a vehicle 2 to be washed.

With a preferred washing and treatment method for a vehicle 2 with a gantry washing system according to invention, the vehicle driver first parks the vehicle 2 to be washed on the marked area 11. The selection of a wash program and any desired extra functions can be made before or after parking the vehicle 2 on the marked area 11.

As a next step, at least the position and orientation of the vehicle 2 on the marked area 11 are detected by the detection device 7.

Next, the gantry 1 moves in such a way that it is aligned with the longitudinal direction of the vehicle and has the vehicle centrally positioned therein.

During the vehicle washing procedure, which may include all the operations of a washing process in a car wash which are known to the state of the art, the gantry 1 can move in this way exactly centrally and parallel to the longitudinal center axis relative to the vehicle 2 to be washed.

The vehicle driver can either be in vehicle 2 during the washing process or leave the vehicle 2 before starting.

The marked area or predetermined parking area 11 in the preferred exemplary embodiment is equipped with a corresponding drainage system and a water treatment plant which are not further depicted.

In a further exemplary embodiment of the present invention, a larger predetermined parking area 11 may be available, on which several vehicles 2 can be parked and sequentially washed by the freely movable gantry 1. In this way, for example, a car park facility could be realized.

In the exemplary embodiment shown, the gantry 1 is connected to a base station not shown in further detail by a system of supply lines. The base station supplies the gantry 1, for example, with electricity and/or compressed air and/or water and/or treatment agents. Likewise, the gantry 1 according to the invention can be equipped with a battery and/or storage tanks for required media such as water or treatment agents in order to achieve even greater autonomy from fixed installations.

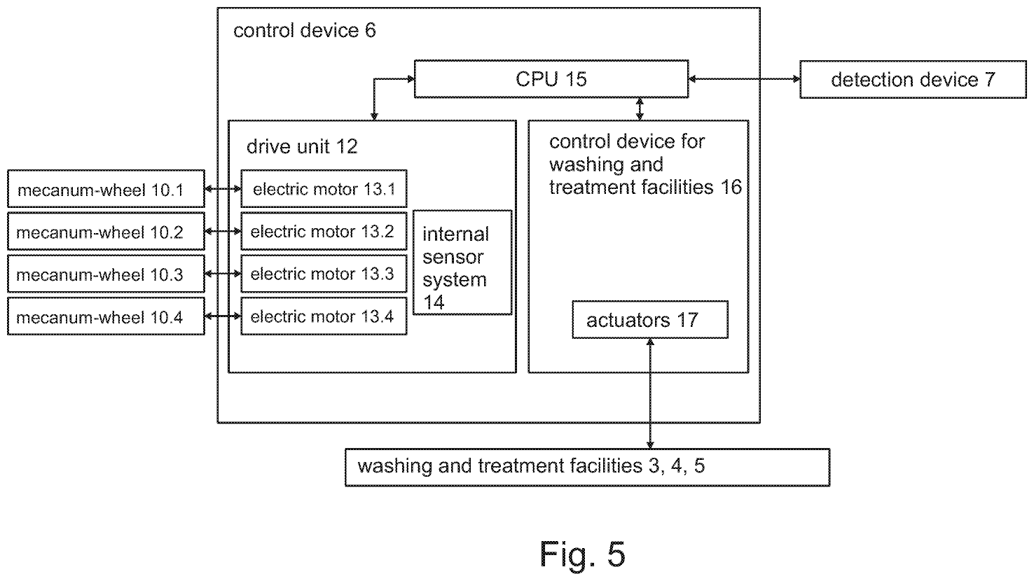

FIG. 5 briefly outlines the control system of the gantry washing system of the invention according to the preferred exemplary embodiment. Here, the control device 6 comprises a CPU 15. Integrated in the control device 6 are a drive unit or a drive unit control 12 and a control device 16 for the washing and treatment facilities 3, 4, 5, which each communicate with the CPU 15. The CPU 15 also communicates with the detection device and receives information from it regarding the position and orientation and, if applicable, the contour of the vehicle 2.

The drive unit 12 has four electric motors 13.1, 13.2, 13.3, 13.4, i.e. one for each mecanum-type-wheel 10.1, 10.2, 10.3, 10.4, and an internal sensor system 14 for detecting the movements of the gantry 1.

The washing and treatment control unit 16 has various actuators 17, e.g. electric drives or pressure pumps for the various washing and treatment units 3, 4, 5, and controls them.

Based on the exemplary preferred embodiment described in detail, various modifications are possible.

For example, a gantry 1 according to the invention does not necessarily have to have washing devices per se; rather, the invention should include any type of gantry systems for vehicle treatment that is common in washing systems.

Likewise, the invention should not be limited to gantry washing systems for motor vehicles. Rather, every comparable system for commercial vehicles and trucks is included.

1. A gantry washing system comprising:
a gantry that can be moved relative to a vehicle, and on which gantry washing devices for washing a vehicle are arranged;
a control device for controlling a movement of the gantry; and
a detection device for detecting a position of the vehicle,
wherein:
the gantry can be freely moved and oriented relative to the vehicle;
the detection device an further detect an orientation of the vehicle; and
the control unit is designed to position and move the gantry in a predetermined manner relative to the detected position and orientation of the vehicle.

2. The gantry washing system according to claim 1, wherein the gantry for being able to be freely moved relative to the vehicle comprises at least two substantially horizontal degrees of freedom for translation and at least one substantially vertical degree of freedom for rotation.

3. The gantry washing system according to claim 1, wherein the gantry has an omnidirectional drive unit by which it can be freely moved relative to the vehicle.

4. The gantry washing system according to claim 1, wherein the gantry can be moved while being suspended without floor contact.

5. The gantry washing system according to claim 1, wherein the gantry washing system comprises a marked parking area and the detection device is designed to identify the marked parking area and/or the gantry is designed to identify its position relative to the marked parking area via an internal sensor system.

6. The gantry washing system according to claim 1, wherein the detection device and/or the control device is/are arranged in or on the gantry.

7. The gantry washing system according to claim 6, wherein the detection device comprises at least:
one optical detection device with at least one camera or a light-sensitive sensory; and/or
one acoustic detection device; and/or
at least one radiation detection device having at least one transmitter and at least one receiver for electromagnetic radiation.

8. The gantry washing system according to claim 7, wherein the detection device is designed to detect a contour of at least a vehicle surface and the control device is designed to calculate an orientation of the vehicle from the detected contour.

9. The gantry washing system according to claim 8, wherein also a height- and/or width profile of the vehicle is detected by the detection device together with the position and orientation of the vehicle.

10. A method for washing a vehicle by a gantry washing system, comprising the steps of:
detecting a position and an orientation of a parked vehicle parked in a predetermined area;
aligning a freely movable gantry on the basis of the detected vehicle position and orientation and positioning the gantry at a predetermined position relative to the vehicle; and
washing the vehicle by gantry washing devices arranged on the gantry.

11. The gantry washing system according to claim 3, wherein the omnidirectional drive unit comprises mecanum type rollers.

12. The gantry washing system according to claim 4, wherein the gantry is movable by a kinematic system on the basis of an articulated arm or a gantry robot.
